(19) United States
(12) Patent Application Publication
(10) Pub. No.: US 2011/0250502 A1
(43) Pub. Date: Oct. 13, 2011

(54) CHEMICALLY GELLED CURABLE COMPOSITION BASED ON EPOXY-AMINE RESINS AND ON IONIC LIQUIDS

(76) Inventors: Serge Gonzalez, Decines (FR); Sauvant-Moynot Valérie, Lyon (FR); Vallet Jacques, Lyon (FR); Grenier Jacky, Vignieu (FR)

(21) Appl. No.: 13/122,158

(22) PCT Filed: Sep. 21, 2009
(86) PCT No.: PCT/FR2009/001112

§ 371 Date: Jun. 15, 2011

(30) Foreign Application Priority Data
Oct. 2, 2008 (FR) 08/05448

(51) Int. Cl. H01M 10/056; H01G 9/155; H01M 10/058; H01G 9/038; C08L 63/00

(52) U.S. Cl. 429/303; 252/62.2; 429/207; 29/623.5; 361/502

(57) ABSTRACT

The invention relates to a chemically gelled curable resin based on epoxy-amine resins and on ionic liquids. The invention advantageously applies to energy accumulation systems, notably electrochemical systems. The curable composition according to the invention can notably constitute an electrolyte usable in a hybrid or electric vehicle battery.

### FIELD OF THE INVENTION

The invention relates to curable compositions, thermosetting compositions for example, chemically gelled, based on epoxy-amine resins and on ionic liquids. The invention advantageously applies to hybrid or electric vehicles. The curable compositions according to the invention can be used as an electrolyte or an electrolytic membrane in electric energy storage systems, in particular in batteries (Li-ion for example).

### BACKGROUND OF THE INVENTION

Rechargeable batteries are particularly promising systems for electric energy storage as regards transport applications (hybrid electric vehicle HEV and electric vehicle EV). Lithium-ion batteries notably provide higher energy density and/or power than the Ni-MH technology currently used in commercial HEVs, and the possible designs are also more varied with a reduced manufacturing cost.

However, the requirements imposed on on-board storage systems are very severe in terms of performance and safety under routine or extreme (overload, high temperatures or temperatures below 0° C.) operating conditions. Potentially flammable in case of short-circuit, the cylindrical or prismatic lithium batteries comprising a liquid electrolyte based on alkyl carbonates currently marketed for portable electronic devices do not provide acceptable safety conditions for Hybrid Electric Vehicle or Electric Vehicle applications. Polymers and polymer gels are therefore studied as electrolytes for Li-ion batteries.

The Li-ion/polymer batteries developed so far meet the increased safety and optimized lightening and design criteria for transport applications, but the operating range is limited to high temperatures, which implies maintaining the battery at temperatures above 60° C. in order to obtain the required performances.

Patent US-2002/0,136,958 A1 describes for example an electrolyte gel for rechargeable batteries that is the result of the reaction of a compound A comprising an amine group and of a compound B comprising an epoxide function or a halogen group in the presence of a liquid comprising a salt, selected from among the conventional organic solvents based on alkyl carbonates.

Hedden et al. (Polymer 48 (2007) 6077-6085) also detail the study of polymer gels resulting from the reaction of polyethyleneimine with a diepoxide of BADGE (bisphenol A diglycidyl ether) type in the presence of DMF (dimethylformamide).

The major drawback is that conventional organic solvents do not have good thermal stability up to 200° C., which makes them delicate to use. Heating these compositions leads to (at least partial) evaporation of the solvent, which requires polymerizing the monomers at low temperature. The gelling times under such conditions are relatively long. Besides, the thermal stability of the gels obtained is poor when the temperature rises.

Ionic liquids (IL) (whose melting point is below 100° C.) are compounds that have particular properties: high breaking down temperature, low or non-existent vapour pressure and high solvation power. According to their chemical structure, they remain liquid within a wide temperature range and they exhibit good ionic conductivity. These compounds are made up of a cation of ammonium, sulfonium, phosphonium, imidazolium, pyridinium, pyrrolidinium type (for example) coupled with an anion of mineral (Li⁺, FeCl₄⁺, PF₆⁺, . . . ), organic (CF₃SO₂)₂N⁻, CF₃CO₂⁻, . . . ), mixed nature or other.

Many publications and patents describe the applications of ionic liquids and these compounds have found pilot or industrial applications in various spheres (chemical synthesis, solvent (transport, extraction), . . . ).

Various studies have been conducted in order to obtain polymer gels comprising ionic liquids. Polymer gels based on PEO (polyethylene oxide), PVDF-HFP (polyvinylidene fluoride-hexafluoropropene), PMMA (polymethyl metacrylate) or PAN (polyacrylonitrile) swollen by a solvent of high dielectric constant, in particular by an ionic liquid, and to which a salt providing conductivity of the ions have been added, constitute the electrolyte of electrochrome devices, supercondensors and lithium or lithium-ion batteries for example.

Patent WO-2005/116,161 A1 describes for example an electrochrome device where the electrolyte precursor is made up of an ionic liquid, a vinylic monomer and a polymerization initiator capable of forming a physical gel by in-situ polymerization.

However, this type of gel has a thermal stability range that is limited by the reversible transition between the gel state and the liquid state that occurs above a certain temperature and involves the same leak risks as liquid electrolytes, for a traction battery application.

We have discovered a new formulation based on at least one ionic liquid and on a curable polymer providing a combination of advantageous properties, in terms of use, thermal stability, ionic conductivity and mechanical strength, in particular for application to electrolytes, notably for batteries operating through ionic insertion and disinsertion mechanisms, such as Li-ion batteries.

The formulation of the composition according to the invention allows to overcome all of the aforementioned drawbacks of the prior art solutions, notably within a context of safety on-board a hybrid or electric vehicle. Furthermore, using ionic liquids enables to work under operating conditions that are not allowed by the organic solvents commonly used in battery systems, notably in Li-ion battery systems.

### OBJECTS OF THE INVENTION

The present invention relates to a chemically gelled curable composition comprising at least one organic compound of epoxide type comprising a functionality above 1, at least one amine and at least one ionic liquid.

More precisely, the amine present in the composition consists of at least one organic compound comprising at least two primary amine functions, or at least one primary amine function and one or more secondary or tertiary amine functions.

In the case of diepoxy-primary diamine systems for example, the functionality can be defined as the number of active sites for one mole of monomer likely to give a chemical reaction. By way of example, this functionality is 2 in the case of one mole of diepoxide because the molecule contains two oxirane functions. The functionality is 4 for one mole of primary diamine containing two primary amine functions because a primary amine function can react with two epoxide functions.

The invention also relates to a method of preparing said composition by mixing the epoxide, amine and ionic liquid components, and polymerization (with or without thermal treatment), without volatile compound release.

The invention also relates to a method of preparing the solid electrode-electrolyte-electrode assembly of an elementary battery cell comprising said composition.

Finally, the invention relates to the use of said curable composition as an electrolyte, notably for energy accumulation (batteries, supercondensors) and energy conversion systems (electrochrome devices, photoelectrochemical solar cells).

Rechargeable batteries or secondary batteries are systems intended for reversible storage of electric energy in electrochemical form, consisting of two electrolyte-impregnated porous electrodes separated by an electrically insulating membrane. The general working principle of batteries is based on reversible electrochemical reactions of oxidation and reduction at the electrodes-electrolyte interfaces, the electrolyte providing transport of the ionic charges between the electrodes.

Supercondensors are rechargeable electricity storage devices consisting of two porous electrodes of large specific surface area separated by an electrically insulating membrane and impregnated with electrolyte. The general working principle of supercondensors is based on the separation of ionic charges and the formation of a double layer at the interface of an electrolyte and of a polarizable electrode, the electrolyte providing transport of the ionic charges between the electrodes.

When a potential difference is applied at the terminals of a supercondensor, the two electrodes behave as two condensors in series and they store the charges at the interfaces.

Electrochrome devices are devices allowing to vary the transmission of the light of the solar spectrum by applying a potential.

Photoelectrochemical solar cells are systems for converting solar energy to electric energy.

### DESCRIPTION OF THE INVENTION

### Summary of the Invention

The present invention relates to a chemically gelled curable composition comprising at least one organic compound of epoxide type comprising a functionality above 1, at least one amine and at least one ionic liquid.

Preferably, the epoxide group is selected from among aromatic, cycloaliphatic, heterocyclic or aliphatic epoxides, substituted or not by aliphatic, cycloaliphatic, aromatic or heterocyclic chains, or elements selected from among fluorine and bromine, the main chain or the substituents optionally comprising carbon and/or hydrocarbon chain segments comprising elements other than carbon, hydrogen and oxygen, and groups likely to react chemically, used alone or in admixture.

Preferably, the amine group is selected from among the organic derivatives comprising at least two primary amine functions, or at least one primary amine function and one or more secondary amine functions, or one or more tertiary amine functions, the amines being of aromatic, heterocyclic, cycloaliphatic or aliphatic type, substituted or not by aliphatic chains, the main chain or the substituents optionally comprising elements selected from among silicon, fluorine, sulfur, chlorine and bromine.

Preferably, the cation of the ionic liquid is selected from among tetraalkylammonium, cations from aromatic cyclic amines (di- and tri, and tetraalkylimidazolium, alkylpyridinium) or from aliphatic cyclic amines (di and tri alkyl piperidinium, dialkylpyrrolidinium, dialkylmorpholinium), tetraalkylphosphonium and trialkylsulfonium, and the anion of the ionic liquid is selected from among halogenides (F⁻, Cl⁻, Br⁻, I⁻ . . . ), the following ions: nitrate, phosphate, sulfate, perchlorate (ClO₄)⁻, (BF₄)⁻, (PF₆)⁻, (AsF₆)⁻, (N(CN)₂)⁻, (C(CN)₃)⁻, the ions (C₄F₉SO₃)⁻, trifluoroacetate (CF₃CO₂)⁻, triflate (CF₃SO₃)⁻, imidides (N(CF₃SO₂)₂)⁻, (CF₃CONCF₃SO₂)⁻, (C(CF₃SO₂)₃)⁻, acetate (CH₃CO₂)⁻ and formiate (HCO₂)⁻.

The curable composition according to the invention can comprise solid or liquid additives selected from the group made up of polymers, salts, fillers selected from among modified (grafted) or non-modified silicas, aluminas, titanium oxides, aluminium oxides, titanates, modified or non-modified clays, micas, ceramics, zeolites, fibers, surfactant compounds.

In an embodiment, the curable composition comprises at least one lithium salt.

The stoichiometric epoxide/amine ratio r (ratio of the functionality products to the concentration of each monomer) advantageously ranges between 0.25 and 1.75.

The invention also relates to a method of preparing a composition according to the invention, comprising:

a. a stage of mixing at least one organic compound of epoxide type comprising a functionality above 1 with at least one amine and at least one ionic liquid, and optionally additives;

b. a stage of polymerizing the polyepoxide-polyamine polymer.

Preferably, the polymerization stage is carried out by thermal treatment.

The epoxide group and the amine group are preferably so selected that the polyepoxide-polyamine pair in epoxy-amine admixture alone after polymerization leads to a glass-transition temperature Tg less than or equal to 150° C., and more preferably less than or equal to 50° C.

The invention also relates to a gelled electrolyte comprising the composition according to the invention.

The object of the invention is also an energy accumulation or conversion system comprising said electrolyte.

The energy conversion system can be of electrochrome device or photoelectrochemical solar cell type.

The energy accumulation system can be of battery or supercondensor type.

Preferably, the battery is a battery operating through ionic insertion and disinsertion mechanisms, more preferably a Li-ion battery.

The invention also relates to the use of a battery and/or of a supercondensor as described above for a hybrid electric vehicle or an electric vehicle.

Finally, the invention relates to a method of preparing an elementary battery cell comprising the following stages:

a) continuous coating deposition of the composition according to the invention on an electrode,

b) covering the coated electrode with the second electrode,

c) in-situ hardening of the composition,

and optionally repeating stages a), b), c) so as to form a solid single or multi-layer <<electrode-electrolyte-electrode>> assembly.

### DETAILED DESCRIPTION OF THE INVENTION

In general terms, the composition according to the invention comprises at least one monomer of multifunctional epoxide type, at least one monomer of amine type (monofunctional or multifunctional primary or multifunctional secondary), and at least one ionic liquid.

The composition is used by mixing the components, followed by a stage of polymerization of the curable epoxy-amine polymer, by heating if need be.

The polymer gels obtained are three-dimensional networks plasticized by at least one ionic liquid. Cohesion between the macromolecular chains is brought by covalent bonds (chemical gels) that provide high stability over time and give the gel an irreversible character in case of temperature rise. This is not the case with physical gels, whose cohesion is provided by interactions between ionic, polar chains or by hydrogen bonds.

The curable resins formulated from polyepoxide resins (or epoxide-epoxy monomers, or comprising an oxirane or glycidyl group, according to designations) in the presence of amine (or amine monomer) type hardeners constitute chemically cross-linked three-dimensional networks, i.e. they irreversibly keep cohesion when heating up to thermal degradation above 250° C. The change from a rigid vitreous behaviour to a supple rubber-like behaviour is characterized by the glass transition associated with the development of a generalized macromolecular mobility in the epoxy-amine network. The formulated epoxy-amine networks have modulable mechanical properties, according to the density of the cross-linking nodes depending on the functionality and on the length of the epoxide and amine monomers, also according to the flexibility of the monomers governed notably by their aromatic, cycloaliphatic or aliphatic nature.

In particular, the epoxy-amine resin formulations are advantageously selected so as to obtain a low glass-transition temperature Tg, typically below ambient temperature.

A polyepoxide-polyamine pair is preferably selected which, in epoxy-amine admixture alone after polymerization, leads to a glass-transition temperature Tg less than or equal to 150° C., more preferably less than or equal to 50° C. The mass ratio between the monomers (epoxide and amine) and the ionic liquid ranges between 1% and 99%, most often between 2% and 98%, and preferably between 5% and 95%.

Polyepoxides

All epoxide monomers can be used in the composition. An aromatic, cycloaliphatic, heterocyclic or aliphatic epoxide can be used indiscriminately. These polyepoxides can carry substituents such as aliphatic, cycloaliphatic, aromatic or heterocyclic chains, or elements such as fluorine and bromine for example. These substituents or the main chain can contain carbon and/or hydrocarbon chain segments comprising elements other than carbon, hydrogen and oxygen, and such as silicon, fluorine, chlorine, bromine and nitrogen for example, and groups likely to react chemically by radical reaction, anionic or cationic reaction, condensation or cycloaddition for example, notably vinyl, allyl, hydroxyl, ester, nitrite groups.

The epoxides used in the composition can be used alone or in admixture, and they advantageously have a number of epoxide functions greater than or equal to two, preferably two to four. One can refer to the various publications in the literature that describe the chemistry, structure, reactivity of epoxide monomers, such as notably: “Handbook of Epoxy Resins,” Lee & Neville, Mc Graw-Hill (1982), “Chemistry and technology of the epoxy Resins,” B. Ellis, Chapman Hall (1993), New York and “Epoxy Resins Chemistry and technology,” C. A. May, Marcel Dekker, New York (1988).

The preferred aromatic polyepoxides are selected from among phenol-novolac and cresol-novolac resins, epoxide resins of bisphenol A, bisphenol F, bisphenol A/F, methylene dianiline, para-amino phenol, epoxyprophylphthalates. N,N′,N″-triglycidyl isocyanurate is for example selected from among the heterocyclic resins.

The following preferred cycloaliphatic polyepoxides can be mentioned: bis-(2,3-epoxycyclopentyl ether), 1,4-cyclohexane dimethanol diglycidyl ether.

The following preferred aliphatic polyepoxides can be mentioned: diethylene glycol diglycidylether, 1,4-butanediol diglycidylether, 1,6-hexanediol diglycidylether, polypropyleneglycol polyepoxides, polyethyleneglycol polyepoxides, trimethyolpropane triglycidylether.

Amines

In general terms, all the organic compounds comprising at least two primary amine functions, or at least one primary amine function and one or more secondary or tertiary amine functions are likely to go into the composition. A mixture of two or more monomers of amine type can be used. It is possible to use organic derivatives comprising at least two primary amine functions, or at least one primary amine function and one or more secondary amine functions or one or more tertiary amine functions. The amine monomers can be of aromatic, heterocyclic, cycloaliphatic or aliphatic type, substituted or not by aliphatic chains. The main chain or the substituents can comprise elements such as silicon, fluorine, sulfur, chlorine and bromine for example.

The aromatic amines that are preferably used are low-toxicity substituted aromatic amines such as 4,4′-aminodiphenylsulfone, 4,4′-methylene-bis(2,6-diethylaniline), 4,4′-(phenylene-diisopropyl)-bis(2,6-dipropyl-aniline), 4,4′-methylene-bis(2-isopropyl-6-methyl-aniline) or M-MIPA, 4,4′-methylene-bis(2,6-diethylaniline) or M-DEA, 4,4′-methylene-bis(3-chloro-2,6-diethylaniline) or M-CDEA, 4,4′-(phenylene-diisopropyl)-bis(2,6-dimethyl-aniline), 4,4′-(phenylene-diisopropyl)-bis(2,6-diethyl-aniline), 4,4′-(phenylene-diisopropyl)-bis(2,6-dipropyl-aniline), 4,4′-(phenylene-diisopropyl)-bis(2,6-diisopropyl-aniline), 4,4′-(phenylene-diisopropyl)-bis(2,6-dimethyl-3-chloro-aniline), 4,4′-(phenylenediisopropyl)-bis(2,6-diethyl-3-chloro-aniline), 4,4′-(phenylene-diisopropyl)-bis(2,6-dipropyl-3-chloro-aniline), 4,4′-(phenylene-diisopropyl)-bis(2,6-diisopropyl-3-chloro-aniline), 3,3′-(phenylene-diisopropyl)-bis(2,6-dimethyl-aniline), 3,3′-(phenylene-diisopropyl)-bis(2,6-diethyl-aniline), 3,3′-(phenylene-diisopropyl)-bis(2,6-dipropyl-aniline), 3,3′-(phenylene-diisopropyl)-bis(2,6-dimethyl-3-chloro-aniline), 3,3′-(phenylene-diisopropyl)-bis(2,6-diethyl-3-chloro-aniline), 3,3′-(phenylene-diisopropyl)-bis(2,6-dipropyl-3-chloro-aniline), 3,3′-(phenylene-diisopropyl)-bis(2,6-diisopropyl-aniline) and 3,3′-(phenylene-diisopropyl)-bis(2,6-diisopropyl-3-chloro-aniline) for example.

The cycloaliphatic amines that are preferably used are amines such as 4,4′-diamino dicyclohexylmethane, 3,3′-dimethyl-4,4′-dicyclohexylmethane, isophorone diamine, menthane diamine.

The aliphatic primary amine monomers that are preferably used are ethylenediamine, diethylenetriamine, triethylenetetramine, piperazinoethylethylene-diamine, diaminoethylpiperazine, aminoethyltris-aminoethylamine, aminoethyl-diaminoethylpiperazine, aminoethylpiperazinoethylethylenediamine, aminoethyl-piperazine, aminoethylethanolamine (such as the amine monomer series marketed by Dow Chemical), amine monomers of polyetheramine type prepared from ethylene oxide, propylene oxide or ethylene oxide/propylene oxide mixtures (such as the Jeffamines series marketed by Hunstman for example), 4,7,10-trioxamidecane-1,13-diamine, poly-Tetrahydrofuranamine (marketed by BASF), polyamidoamines, polyaminoimidazolines, unbranched or hyperbranched polyethyleneimines (PEI) and polyalkyleneamines.

The secondary amines derived from the above compounds can also be used.

The preferred reactive organic compounds that can go into the composition are notably described in detail in patent application US-2008/0,188,591 A1 .

Ionic Liquids

In general, ionic liquids (IL) are defined as molten salts whose melting point is below 100° C. The chemical structure of an ionic liquid can be represented by an anion (A) and a cation (B⁺). In the literature, more particularly, RTILs (Room Temperature Ionic Liquids) are defined as molten salts liquid at ambient temperature. The physical and chemical properties of these compounds are greatly influenced by the nature of the anion and of the cation.

Cations and anions resistant to heat, reduction and oxidation are preferably selected, which have a wide electrochemical window in case of use as a battery or accumulator electrolyte.

Without limiting the scope of the invention, it is possible to use ionic liquids alone or in admixture, whose cation is selected from among tetraalkylammonium, cations from aromatic cyclic amines (di-, tri- and tetra-alkylimidazolium, alkylpyridinium) or from aliphatic cyclic amines (di and tri alkyl piperidinium, dialkylpyrrolidinium, dialkylmorpholinium), or from among tetraalkylphosphonium, trialkylsulfonium, and the anion is selected from among halogenides (F⁻, Cl⁻, Br⁻, I⁻ . . . ), the following ions: nitrate, phosphate, sulfate, perchlorate (ClO₄)⁻(BF₄)⁻, (PF₆)⁻, (AsF₆)⁻, (N(CN)₂)⁻, (C(CN)₃)⁻ or from among other organic anions such as the following ions: (C₄F₉SO₃)⁻, trifluoroacetate (CF₃CO₂)⁻, triflate (CF₃SO₃)⁻, imidides (N(CF₃SO₂)₂)⁻, (CF₃CONCF₃SO₂)⁻, (C(CF₃SO₂)₃)⁻, acetate (CH₃CO₂)⁻ and formiate (HCO₂)⁻.

The anion (A⁻) can be for example: PF₆⁻, CₙF₂ₙ₊₁CO₂⁻, CₙF₂ₙ₊₁SO₃⁻, (C₂F₅SO₂)₂N⁻, (CF₃SO₂)₂N⁻, (CF₃SO₂)₃C⁻, (CN)₂N⁻, etc.

The cation (B⁺) can be, for example, a heterocyclic cation such as pyrrolium, pyridinium, imidazolium, pyrazolium, benzimidazolium, indolium, quinolinium, pyrrolidinium, piperidinium, piperazinium, morpholinium or an alkylammonium. The cation can comprise one or more alkyl, cycloalkyl, phenyl substituents, or reactive functions such as acid, ester, hydroxyl, isocyanate for example, or one or more polymerizable groups such as vinyls, acryls, metacryls, allyls or oxetanes for example.

Preferably, an ionic liquid whose melting point is below 100° C. and whose properties are compatible with the application considered is used.

Method of Preparing the Curable Composition and the Electrolyte According to the Invention

The polymer resulting from the reaction between at least one epoxide monomer as described above and at least one amine monomer as described above is plasticized by an ionic liquid. In order to adjust the characteristics of the composition, it is possible to choose either stoichiometric conditions for the epoxide and amine functions or stoichiometric unbalance.

Stoichiometry can be defined as the amount or the proportion of substances that will give a chemical reaction.

Stoichiometric ratio r can be defined as the ratio of the functionality products to the concentration of each monomer.

The functionality can be defined as the number of active sites for one mole of monomer likely to give a chemical reaction. As mentioned above, this functionality is for example 2 in the case of one mole of diepoxide because the molecule contains two oxirane functions. The functionality is 4 for one mole of primary diamine that contains two primary amine functions because a primary amine function can react with two epoxide functions.

In the case of commercial products, r is calculated from the epoxide index expressed in equivalent per kilogram (Eq/kg) or from the epoxide equivalent expressed in gram of resin per equivalent (g/Eq). In the case of a diamine, it is possible to use the amine value that corresponds to the number of amine equivalents in 1 kg of substance or the amine index that corresponds to the amount of amine in one gram of substance. The ISO 3001 and ISO 9702 standards indicate the determination methods.

A ratio r ranging between 0.25 and 1.75, most often between 0.75 and 1.25, and preferably between 0.95 and 1.05 is advantageously kept to.

In order to adjust the properties of the curable composition, it is possible to use chain <<extending>> agents such as multifunctional secondary amines for example, softening agents such as primary monoamines and chain limiting agents or monofunctional chain end agents such as monoepoxides or secondary monoamines for example, or any chain end agent known to the person skilled in the art.

It is also possible to use a chain end agent comprising reactive groups (likely to give a chemical coupling reaction) in its chemical structure.

The monomer polymerization reaction and the formation of the three-dimensional network can be obtained in various manners, by thermal treatment, or at ambient temperature if the reactivity of the monomers allows it, by UV radiation and radiations for example. The specific feature of the composition allows to use the polymerization system by thermal treatment at high temperature without the limitation associated with the liquid solvent evaporation since the ionic liquid is not volatile. Preferably, a treatment of this type is applied in order to carry out the polymerization reaction, which reduces the polymerization time.

The composition can also comprise agents accelerating the amine-epoxide reaction or allowing homopolymerization of the oxirane groups. Alcohols, phenols, imidazoles, boron derivatives, tertiary amines can be mentioned for example.

The modification (improvement) of the mechanical properties and/or of the electric and thermal conductivity and/or of the rheology is often the result of the addition of solid or liquid additives such as polymers, salts, fillers, surfactant compounds, etc.

Fillers such as, for example, modified (grafted) or non-modified silicas, aluminas, titanium oxides, aluminium oxides, titanates, modified or non-modified clays, micas, ceramics, zeolites, fibers can be used. All these fillers can be present as nanofillers, i.e. fillers of nanometric size.

It is also possible to modify the rheology of the composition through solubilization of polymers of more or less high mass (ethylene polyoxide, poly(vinylidene fluoride-hexafluoropropene) for example). All the statistical, alternate, sequenced polymers or oligomers of soluble-block copolymer type in ionic liquids can be used.

The chemically gelled curable composition can be used by means of conventional devices known to the person skilled in the art. It is thus possible to use devices such as moulds in order to make plates, localized deposition systems such as syringes for example, allowing to encapsulate or to cover a given material, or applicators allowing to obtain films. It is also possible to use systems for continuous deposition on films, metallic strips, or another organic or mineral chemical composition by coating, by means of a film applicator or filmograph for example.

The polyepoxide/polyamine type resins are plasticized by the ionic liquids: the plasticized materials are homogeneous or heterogeneous (phase segregation) depending on the nature of the components. For some compositions, the material exhibits the syneresis phenomenon (spontaneous aggregation of the particles of a gel, with possible separation of the liquid), which can be useful to promote ionic charge transfer from the electrolyte to the electrodes.

The electrolytes and electrolytic membranes based on the composition according to the invention can be prepared in environments with reduced oxygen and water contents, by in-situ polymerization of the epoxide and amine monomers in the presence of at least one ionic liquid, the initial composition being optionally filled with salts or other fillers beforehand. Characterizations using conventional analysis techniques can be carried out on the hardened composition. In particular, DSC measurements allow to determine the glass-transition temperature Tg of the gelled polymer; thermogravimetry (ATG) measurements allow to establish the thermal stability of the materials; ionic conductivity measurements at ambient temperature are performed by electrochemical impedance spectroscopy.

Applications of the Composition According to the Invention

Electrolyte

The curable composition of the invention can be formulated in order to meet a precise application.

In order to illustrate one of the many applications of the invention, the preparation of electrolytes for energy conversion or accumulation systems can be mentioned.

The plasticized curable composition (chemical gel) according to the invention can be used as a base for an electrolyte composition, notably for batteries, supercondensors, electrochrome devices or photoelectrochemical solar cells.

A composition for electrochrome devices allows to vary the transmission of the light of the solar spectrum by applying a potential.

A composition for photoelectrochemical solar cells allows to convert the solar energy to electric energy.

The composition according to the invention can also be used as a detector composition (variation of ionic conductivity a according to the exposure medium).

Such a composition of polyepoxide/polyamine type polymer plasticized by an ionic liquid, used as the base for the formulation of an electrolyte of chemically cross-linked gel type, is interesting for securing batteries operating through ionic insertion and disinsertion mechanisms in electrodes, notably Li-ion batteries.

Salts can be added to the composition according to the invention, for an application as a battery electrolyte, notably lithium salts for Li-ion batteries, in order to increase the concentration of the charge carriers between positive and negative electrodes. In the composition according to the invention, it is possible to use notably a salt comprising at least one lithium cation, and preferably LiPF₆, LiAsF₆, LiClO₄, LiN(CF₃SO₂)₂, LiBF₄, LiCF₃SO₃ and LISBF₆ for example.

Elementary Battery Cell

The invention also relates to a method of preparing an elementary battery cell where the curable composition according to the invention (used as the electrolyte) is continuously deposited by coating on an electrode, then the coated electrode is covered with the second electrode. This operation is possibly repeated one or more times so as to form a multi-layer assembly (while adding insulating strips or sheets). In-situ hot and/or continuous curing allows to obtain a solid assembly between the electrode, the electrolyte and the second electrode. An electrode preferably consists of a band comprising a metallic collector that has first been coated with a composite electrode material (inorganic powders with a polymer binder).

Preferably, the battery is a secondary battery operating through ionic insertion and disinsertion mechanisms, more preferably a lithium-ion type battery.

Arranging the elementary battery cells thus prepared in series and/or in parallel can allow to obtain a battery advantageously usable in a hybrid electric vehicle or an electric vehicle.

### EXAMPLES

The following examples illustrate the invention by way of non limitative example and they present compositions prepared from the following compounds:

Epoxides:
1,4-Butanediol diglycidyl ether (Aldrich), named C1,
Araldite DY-C marketed by HUNSTMAN, named C2
Araldite LY 556 marketed by HUNSTMAN, named C3
Epikote 862 marketed by RESOLUTION, named C4
GY 298 marketed by HUNSTMAN, named C5.

Amines:
Jeffamine EDR 148 marketed by HUNSTMAN, named C6
Jeffamine D 400 marketed by HUNSTMAN, named C7
Jeffamine D 2000 marketed by HUNSTMAN, named C8
Jeffamine M 600 marketed by HUNSTMAN, named C9.

Ionic Liquids:
1-Butyl-3-methylimidazolium bis(trifluoromethanesulfonyl)imide marketed by SOLVIONIC, named C10
1-Butyl-1-methylpyrrolidinium bis(trifluoromethanesulfonyl)imide marketed by SOLVIONIC, named C11.

Conducting Salt:
Lithium bis(trifluoromethanesulfonyl)imide marketed by SOLVIONIC, named C12.

Filler (Silica):
Cab-O—Sil TS 720 marketed by Cabot corporation, named C13.

Conventional Solvents:
DMF (Dimethylformamide) named C14
Ethylene carbonate (EC) named C15
Propylene carbonate (PC) named C16.

### Examples 1 to 4

### Preparation of Compositions 1 to 4

Various composition preparation methods can be implemented.

One of the methods of preparing the composition can be described as follows. In a clean and dry glass reactor, under dry nitrogen, a lithium salt is solubilized in the ionic liquid. For high salt concentrations, hot solubilization is advantageously carried out.

The polyepoxide and the amine are fed into a second glass reactor under dry nitrogen and at ambient temperature. After 10-min stirring, the lithium salt solution is added. The homogeneous mixture is degassed for 5 minutes at 50° C. under vacuum at 5 mm Hg. It is then poured into a glass mould consisting of two plates provided with a non-adhesive coating separated by a joint adjusting the thickness. The mould is fed into an aerated dryer where a thermal treatment is carried out for 3 hours at 50° C. and for 4 hours at 100° C. The plate obtained is then removed from the mould, placed between two adsorbent paper sheets, then dried at 60° C. under vacuum at 0.05 mm Hg and stored under air-tight conditions.

Table 1 shows the compositions obtained.

TABLE 1

| Example | C2 (wt. %) | C6 (wt. %) | C7 (wt. %) | C10 (wt. %) |
|---|---|---|---|---|
| 1 | 82.5 | 17.5 | X | 0 |
| (not in accordance) | | | | |
| 2 | 41.25 | 8.75 | X | 50 |
| 3 | 61.9 | X | 38.1 | 0 |
| (not in accordance) | | | | |
| 4 | 30.94 | X | 19.06 | 50 |

Table 1 describes two compositions in accordance with the invention and two compositions that are not in accordance with the invention (without ionic liquid).

### Example 2

### Measurement of the Glass-Transition Temperature Tg

The glass-transition temperature Tg of the solid polymers obtained is measured using a DSC Q100 device from TA Instruments, from −70° C. to 200° C. under nitrogen, with a heating ramp of 10° C./min.

TABLE 2

| Example | Tg (° C.) |
|---|---|
| 1 | >0 |
| 2 | <−5 |
| 3 | >−10 |
| 4 | <−10 |

The results of Table 2 above show a decrease in the value of the glass-transition temperature of the polymer through addition of an ionic liquid.

The ionic liquid thus acts as a polymer plasticizer.

### Examples 5 to 9

### Preparation of Compositions 5 to 9

In order to illustrate the applications as electrolytes of the polymers plasticized by ionic liquids, the formulations detailed in the following tables are prepared:

TABLE 3

| | | | C7 (wt. %) | | |
|---|---|---|---|---|---|
| | | C6 (wt. %) | 1 other | | |
| Example | C2 (wt. %) | 1 amine | amine | C10 (wt. %) | C12 (wt. %) |
| 5 | 39.12 | 8.29 | 0 | 47.42 | 5.17 |
| 6 | 33.97 | 7.20 | 0 | 41.17 | 17.66 |
| 7 | 29.34 | 0 | 18.08 | 47.42 | 5.16 |
| 8 | 25.43 | 0 | 15.67 | 41.1 | 17.8 |
| 9 | 23.19 | 0 | 14.29 | 37.48 | 25.04 |

In the second series of examples, the compositions are prepared by varying the nature of the amine monomers and the salt contents.

### Examples 10 to 14

### Preparation of Compositions 10 to 14

TABLE 4

| | C1 | C3 | C4 | C7 | C10 | C11 | C12 |
|---|---|---|---|---|---|---|---|
| Example | (wt. %) | (wt. %) | (wt. %) | (wt. %) | (wt. %) | (wt. %) | (wt. %) |
| 10 | 23.53 | 0 | 0 | 23.86 | 47.39 | 0 | 5.22 |
| 11 | 23.53 | 0 | 0 | 23.86 | 0 | 47.39 | 5.22 |
| 12 | 0 | 30.86 | 0 | 16.51 | 47.38 | 0 | 5.25 |
| 13 | 0 | 30.86 | 0 | 16.51 | 0 | 47.38 | 5.25 |
| 14 | 0 | 0 | 29 | 18.36 | 47.37 | 0 | 5.27 |

In this third series of tests, the compositions are prepared by varying the nature of the epoxide monomers and of the ionic liquids.

### Examples 15 and 16

### Preparation of Compositions 15 and 16

In order to improve the conductivity or the mechanical strength, or to settle viscosity and reactivity problems, fillers and/or additives can be incorporated, or reactant mixtures such as those shown in the examples of Table 15 can be used.

TABLE 5

| Example | C1 (wt. %) | C7 (wt. %) | C11 (wt. %) | C12 (wt. %) | C13 (wt. %) |
|---|---|---|---|---|---|
| 15 | 20.62 | 20.62 | 41.24 | 17.52 | 0 |
| 16 | 22 | 22 | 38.28 | 16.27 | 1.45 |

### Examples 17 and 18

### Preparation of Compositions 17 and 18

The examples presented in Table 6 illustrate the possibility of using epoxide monomer mixtures and amine monomer mixtures, including a primary monoamine in the formulation, without ionic liquid (example 17, not in accordance) or with ionic liquid (example 18, in accordance).

TABLE 6

| | C5 | C3 | C6 | C9 | C11 | C12 |
|---|---|---|---|---|---|---|
| Example | (wt. %) | (wt. %) | (wt. %) | (wt. %) | (wt. %) | (wt. %) |
| 17 | 57.16 | 19.05 | 6.55 | 17.24 | 0 | 0 |
| 18 | 22.3 | 7.4 | 2.6 | 6.7 | 36 | 25 |

In all cases, self-supporting films are obtained. The ionic conductivity is measured at ambient temperature using a Gamery type device in a frequency range from 100 to 10⁵ Hz on dried materials at 60° C. for three days.

Results: aspect, glass-transition temperature Tg and ionic conductivity

Table 7 shows the results obtained for the compositions of examples 1 to 18. The value of the relative ionic conductivity corresponds to the ratio of the value of the ionic conductivity measured for the sample to the value of the ionic conductivity of example 1. The results show the conductivity gain provided by the compositions according to the invention in relation to the polymer alone in the case of an electrolyte application.

TABLE 7

| | | | Relative ionic |
|---|---|---|---|
| Example | Aspect | Tg (° C.) | conductivity |
| 1 | Transparent | >0 | 1 |
| (not in accordance) | | | |
| 2 | Opaque-Syneresis | <−5 | 9.7 × 10⁺⁵ |
| 3 | Transparent | >−10 | 1 |
| (not in accordance) | | | |
| 4 | Opaque-Syneresis | <−10 | 7 × 10⁺⁵ |
| 5 | Opaque-Syneresis | <0 | 6.4 × 10⁺⁵ |
| 6 | Transparent- | <−10 | 3.7 × 10⁺⁶ |
| | Syneresis | | |
| 7 | Transparent- | <−20 | 1 × 10⁺⁷ |
| | Syneresis | | |
| 8 | Transparent- | <−25 | 7.5 × 10⁺⁶ |
| | Syneresis | | |
| 9 | Transparent-Dry | <−25 | 5.4 × 10⁺⁶ |
| 10 | Transparent-Dry | <−25 | 1 × 10⁺⁷ |
| 11 | Transparent- | <−25 | 7.4 × 10⁺⁶ |
| | Syneresis | | |
| 12 | Transparent- | <0 | 3.37 × 10⁺⁶ |
| | Syneresis | | |
| 13 | Opaque-Dry | >0 | 1.6 × 10⁺⁵ |
| 14 | Transparent-Dry | <−5 | 2.3 × 10⁺⁶ |
| 15 | Transparent-Dry | <−20 | 5.4 × 10⁺⁵ |
| 16 | Transparent-Dry | <−20 | 4.5 × 10⁺⁶ |
| 17 | Transparent-Dry | >−20 | 1 |
| (not in accordance) | | | |
| 18 | Transparent-Dry | <−20 | 1 × 10⁺⁶ |

### Examples 19 to 21

### Preparation of Compositions 19 to 21

A series of formulations is prepared by substituting DMF (dimethylformamide) or an EC/PC mixture (50%/50% by weight) for the ionic liquid. In this case, polymerization is performed in a metal cup coated with an anti-adhesive cloth. Table 8 shows the formulations prepared.

TABLE 8

| | C1 | C7 | C12 | C10 | C 14 | C 15 | C 16 |
|---|---|---|---|---|---|---|---|
| | (wt. | (wt. | (wt. | (wt. | (wt. | (wt. | (wt. |
| Example | %) | %) | %) | %) | %) | %) | %) |
| 19 (not in | 23.53 | 23.86 | 5.22 | 0 | 47.39 | 0 | 0 |
| accordance) | | | | | | | |
| 20 (not in | 23.53 | 23.86 | 5.22 | 0 | 0 | 23.695 | 23.695 |
| accordance) | | | | | | | |
| 21 (in | 23.53 | 23.86 | 5.22 | 47.39 | 0 | 0 | 0 |
| accordance) | | | | | | | |

The samples are weighed before the polymerization cycle at 50° C. for 3 hours and 100° C. for 4 hours in a dryer.

Table 9 shows the mass variations calculated after cooling. M1 corresponds to the initial relative mass, M2 to the final relative mass.

TABLE 9

| Example | M1 | M2 | Mass variation (%) |
|---|---|---|---|
| 19 | 100 | 54.09 | 45.91 |
| (not in accordance) | | | |
| 20 | 100 | 61.48 | 38.52 |
| (not in accordance) | | | |
| 21 | 100 | 99.53 | <0.5 |
| (in accordance) | | | |

Examples 19 to 21 illustrate the interest of using an ionic liquid that allows to carry out the stage of polymerization by thermal treatment without significant loss of mass. The advantages are certain in terms of equipment gain (no volatile organic compound (VOC) suction and preparation of the element in an air-tight environment). Conventional organic solvents are unusable for this type of operating procedure.

Thermogravimetry analyses (ATG) in air from 50° C. to 200° C., with a 10° C./min heating ramp, are conducted from the samples obtained. The loss of mass measured is −3.32% for sample 19, −11.67% for sample 20, and within the device measuring limits for sample 21 (−0.17%). These tests show the interest of using an ionic liquid as the plasticizer in an epoxy-amine polymer to guarantee thermal stability of the gel up to 200° C.

The results obtained for the compositions according to the invention, compared with a reference material polymerized without ionic liquid (examples 1 and 3), show an additional plasticization of the network by the ionic liquid and a conductivity improvement. The thermal stability of the mixtures during implementation is highlighted by comparison with a composition known from the prior art, by polymerization of an epoxy-amine resin in the presence of a conventional solvent (examples 19 and 20).

1) A chemically gelled curable composition comprising at least one organic compound of epoxide type comprising a functionality above 1, at least one organic compound comprising at least two primary amine functions, or at least one primary amine function and one or more secondary amine or tertiary amine functions, and at least one ionic liquid.

2) A curable composition as claimed in claim 1, wherein the epoxide group is selected from among aromatic, cycloaliphatic, heterocyclic or aliphatic epoxides, substituted or not by aliphatic, cycloaliphatic, aromatic or heterocyclic chains, or elements selected from among fluorine and bromine, the main chain or the substituents optionally comprising carbon and/or hydrocarbon chain segments comprising elements other than carbon, hydrogen and oxygen, and groups likely to react chemically, used alone or in admixture.

3) A curable composition as claimed in claim 1, wherein the amine functions are of aromatic, heterocyclic, cycloaliphatic or aliphatic type, substituted or not by aliphatic chains, the main chain or the substituents optionally comprising elements selected from among silicon, fluorine, sulfur, chlorine and bromine.

4) A curable composition as claimed in claim 1, wherein the cation of the ionic liquid is selected from among tetraalkylammonium, cations from aromatic cyclic amines (di- and tri, and tetraalkylimidazolium, alkylpyridinium) or from aliphatic cyclic amines (di and tri alkyl piperidinium, dialkylpyrrolidinium, dialkylmorpholinium), tetraalkylphosphonium and trialkylsulfonium, and the anion of the ionic liquid is selected from among halogenides (F⁻, Cl⁻, Br⁻, I⁻ . . . ), the following ions: nitrate, phosphate, sulfate, perchlorate [ClO₄]⁻, [BF₄]⁻, [PF₆]⁻, [AsF₆]⁻, [N(CN)₂]⁻, [C(CN)₃]⁻, the ions [C₄F₉SO₃]⁻, trifluoroacetate [CF₃CO₂]⁻, triflate [CF₃SO₃]⁻, imidides [N(CF₃SO₂)₂]⁻, [CF₃CONCF₃SO₂]⁻, [C(CF₃SO₂)₃]⁻, acetate [CH₃CO₂]⁻ and formiate [HCO₂]⁻.

5) A curable composition as claimed in claim 1, comprising solid or liquid additives selected from the group made up of polymers, salts, fillers selected from among modified (grafted) or non-modified silicas, aluminas, titanium oxides, aluminium oxides, titanates, modified or non-modified clays, micas, ceramics, zeolites, fibers, surfactant compounds.

6) A curable composition as claimed in claim 5, containing at least one lithium salt.

7) A curable composition as claimed in claim 1, wherein the stoichiometric epoxide/amine ratio r (ratio of the functionality products to the concentration of each monomer) ranges between 0.25 and 1.75.

8) A method of preparing a composition as claimed in claim 1, comprising:
a. a stage of mixing at least one organic compound of epoxide type comprising a functionality above 1 with at least one amine and at least one ionic liquid, and optionally additives;
b. a stage of polymerizing the polyepoxide-polyamine polymer.

9) A preparation method as claimed in claim 8, wherein the polymerization stage is carried out by thermal treatment.

10) A preparation method as claimed in claim 8, wherein the epoxide group and the amine group are preferably so selected that the polyepoxide-polyamine pair in epoxy-amine admixture alone after polymerization leads to a glass-transition temperature Tg measured using the DSC technique less than or equal to 150° C.

11) A preparation method as claimed in claim 10, wherein the epoxide group and the amine group are preferably so selected that the polyepoxide-polyamine pair in epoxy-amine admixture alone after thermal treatment leads to a glass-transition temperature Tg measured using the DSC technique less than or equal to 50° C.

12) A gelled electrolyte comprising the composition as claimed in claim 1.

13) An energy accumulation or conversion system comprising an electrolyte as claimed in claim 12.

14) An energy conversion system as claimed in claim 13 of electrochrome device or photoelectrochemical solar cell type.

15) An energy accumulation system as claimed in claim 13 of battery or supercondensor type.

16) An energy accumulation system as claimed in claim 15 of battery type operating through ionic insertion and disinsertion mechanisms.

17) An energy accumulation system as claimed in claim 16 of Li-ion battery type.

18) Use of a battery and/or of a supercondensor as claimed in claim 15 for a hybrid electric vehicle or an electric vehicle.

19) A method of preparing an elementary battery cell comprising the following stages:
a) continuous coating deposition of the composition as claimed in claim 1 on an electrode,
b) covering the coated electrode with the second electrode,
c) in-situ hardening of the composition,
and optionally repeating stages a), b), c) so as to form a solid single or multi-layer <<electrode-electrolyte-electrode>> assembly.
